(19) United States
(12) Patent Application Publication
(10) Pub. No.: US 2005/0061370 A1
(43) Pub. Date: Mar. 24, 2005

(54) Vacuum packaging appliance spice rack

(76) Inventors: Landen Higer, Alameda, CA (US); Charles Wade Albritton, Hercules, CA (US)

Correspondence Address: PERKINS COIE LLP, P.O. BOX 2168, MENLO PARK, CA, 94026, US

(21) Appl. No.: 10/911,231

(22) Filed: Aug. 3, 2004

Related U.S. Application Data
(60) Provisional application No. 60/495,777, filed on Aug. 16, 2003.

(51) Int. Cl. F15B 5/00

(52) U.S. Cl. 137/221

(57) ABSTRACT

A method and apparatus for a vacuum packaging appliance spice rack accessory is illustrated and described. In one embodiment, the invention is an apparatus for use with a vacuum appliance. The apparatus includes a first module including a manifold and a drawer. The manifold has a cavity sized to receive the drawer, and a set of valves, each valve of the set of valves set into a wall of the manifold between an internal cavity of the manifold and an exterior surface of the manifold. The manifold has a drawer valve, the drawer valve set into a wall between the cavity to receive the drawer and the internal cavity. The manifold has a hose valve, the hose valve set into an exterior wall of the manifold between the internal cavity and a back end of the manifold. The drawer is sized to fit into the cavity to receive the drawer. The drawer has a valve positioned to mate with the drawer valve of the manifold. The drawer is sized to fill the cavity and to seal an opening of the cavity.

### CROSS REFERENCE TO RELATED APPLICATIONS

This application claims the benefit of U.S. Provisional Patent Application No. 60/495,777 filed Aug. 16, 2003, entitled, “Vacuum Packaging Appliance Spice Rack Accessory”, by Charles Wade Albritton, and which is hereby incorporated by reference in its entirety.

The present invention relates to the field of storage technology. More particularly, the present invention relates to vacuum appliances for consumer and industrial applications.

### BACKGROUND

Consumer products involving vacuuming and sealing plastic bags have grown in popularity over the years. The basic model available includes a seal wire which seals the length of the bag and a vacuum pump which pumps air out of the bag prior to sealing. This model works well enough to have sold and inspired imitation.

Unfortunately, the model described provides vacuum capability only for plastic bags. Much food and similar material is better stored in drawers. Drawers are not obviously suitable for use with vacuum. Providing a sealed environment in which a component may slide in and out may be a challenge. However, it may be useful to adapt drawers for use with vacuum applications.

In particular, adapting a spice rack or cabinet for use with vacuum sealing may be useful, as spices are likely to be used in small quantities at varying and often long intervals. Purchasing spices in small quantities tends to be expensive. Storing spices in significant quantities over long periods of time tends to result in the spices losing their potency or flavor, and thus defeats the purpose of purchasing the spices in sufficient quantities to either justify long-term storage or provide for significant discounts. As such, a spice rack that allows for vacuum storage of spices may be useful.

### SUMMARY

A method and apparatus for a vacuum packaging appliance spice rack is illustrated and described. The invention may be embodied as an apparatus or a method. An apparatus within the spirit and scope of the invention may include a container with a cavity sized to receive a drawer, a drawer, and valves positioned to allow for evacuation of the container and the drawer. An apparatus within the spirit and scope of the invention may be used with a vacuum appliance or may be self-contained. A method within the spirit and scope of the present invention may include putting a drawer into a sealed container, evacuating the container, and opening the drawer without unsealing the rest of the container.

In one embodiment, an apparatus for use with a vacuum system includes a manifold having a set of cavities sized to receive drawers, and having a set of valves. Each valve of the set of valves is set into a wall of the manifold between an internal cavity of the manifold and a cavity of the set of cavities. The apparatus also includes a set of drawers, each drawer sized to fit into a cavity of the set of cavities. Each drawer has a valve positioned to mate with the valve of a cavity of the set of cavities. The manifold further includes a back wall adjacent to the internal cavity, the back wall including a hose valve therethrough. The hose valve is formed to couple with a hose. The vacuum system may either be an integral part of the apparatus or separate from the apparatus.

In an alternate embodiment, an apparatus for use with a vacuum system includes a first module including a manifold and a drawer. The manifold has a cavity sized to receive the drawer, and a set of valves, each valve of the set of valves set into a wall of the manifold between an internal cavity of the manifold and an exterior surface of the manifold. The manifold has a drawer valve, the drawer valve set into a wall between the cavity to receive the drawer and the internal cavity. The manifold has a hose valve, the hose valve set into an exterior wall of the manifold between the internal cavity and a back end of the manifold. The drawer is sized to fit into the cavity to receive the drawer. The drawer has a valve positioned to mate with the drawer valve of the manifold. The drawer is sized to fill the cavity and to seal an opening of the cavity. The vacuum system may either be an integral part of the apparatus or separate from the apparatus.

In another alternate embodiment, an apparatus for use with a vacuum appliance includes a means for holding food. The apparatus also includes a means for receiving the means for holding food. The apparatus further includes a means for evacuating the means for receiving and the means for holding. The vacuum appliance may either be an integral part of the apparatus or separate from the apparatus.

In yet another alternate embodiment, a method of storing food includes filling a first drawer. The method also includes inserting the first drawer into a first cavity. The method further includes evacuating the first cavity and first drawer.

In still another alternate embodiment, an apparatus includes a manifold having a set of cavities sized to receive drawers, and having a set of valves. Each valve of the set of valves is set into a wall of the manifold between an internal cavity of the manifold and a cavity of the set of cavities. The apparatus further includes a set of drawers. Each drawer is sized to fit into a cavity of the set of cavities. Each drawer has a valve positioned to mate with the valve of a cavity of the set of cavities. The apparatus also includes a lower cavity below the manifold and the cavities to receive the drawers. The lower cavity is sealed from the manifold, and is defined by walls contiguous with walls of the manifold and a bottom connected thereto. The apparatus further includes a vacuum pump housed in the lower cavity. Moreover, the apparatus includes a hose coupling the vacuum pump to the inner cavity of the manifold. In certain other embodiments, the cavity for housing the vacuum pump may either be located to one side of the manifold, behind the manifold or above the manifold, and thus may vary from implementation to implementation.

In yet another embodiment, an apparatus includes a manifold having a set of compartments and each compartment is sized to receive a container. Each compartment includes a container carrier and associated guide track for attaching a container. The compartment includes a valve interface and corresponding valve for putting the compartment in communication with a vacuum system. The vacuum system can include a vacuum reservoir and a vacuum sensor. The vacuum system is adapted to evacuate the compartments automatically when the vacuum sensor senses that the vacuum level in the vacuum reservoir has fallen below a pre-determined vacuum level. The containers can be of a shape that is adapted for ease in refilling or dispensing content that is stored in the container. The container may optionally include graduated measurement markings for measuring the content stored in the container. The container may optionally include a measuring spoon that is detachably affixed to the container.

### BRIEF DESCRIPTION OF THE DRAWINGS

FIG. 1 illustrates an embodiment in perspective view of a spice rack, which may be useful with a vacuum appliance.

FIG. 2 illustrates an embodiment in a cutaway view along line A of a spice rack, which may be useful with a vacuum appliance.

FIG. 3 illustrates an embodiment in a back view of a spice rack, which may be useful with a vacuum appliance.

FIG. 4 illustrates an alternate embodiment in a perspective view of a spice rack which may be useful with a vacuum appliance

FIG. 5 illustrates an alternate embodiment in a cutaway view along line B of a spice rack, which may be useful with a vacuum appliance.

FIG. 6 illustrates an alternate embodiment in a back view of a spice rack, which may be useful with a vacuum appliance.

FIG. 7 illustrates an alternate embodiment of the spice rack of FIGS. 4-6 as it may be used.

FIG. 8 illustrates an embodiment of a process of using a spice rack with a vacuum appliance.

FIG. 9 illustrates an alternate embodiment of a process of using a spice rack with a vacuum appliance.

FIG. 10 illustrates an embodiment of a vacuum appliance as it may be used with an embodiment of a lid.

FIG. 11 illustrates an embodiment in a cutaway side view of a lid that may be used with a vacuum appliance.

FIG. 12 illustrates an embodiment of a front view of a vacuum appliance.

FIG. 13 illustrates the embodiment of a back view of a vacuum appliance.

FIG. 14 illustrates an alternate embodiment in a perspective view of a spice rack with a vacuum capability.

FIG. 15 illustrates a frontal view of an alternate embodiment of a spice rack having drawers of various sizes.

FIG. 16 illustrates a container or drawer having a shape that is adapted for ease in refilling or dispensing material stored in the container, according to one embodiment.

FIG. 17 illustrates one compartment of an alternate embodiment that includes a multi-compartment cabinet and a plurality of containers.

FIG. 18 illustrates a drawer handle that is adapted to vent the interior atmosphere of the drawer when the handle is pulled, according to certain embodiments.

FIG. 19 illustrates a drawer handle is adapted to vent the interior atmosphere of the drawer when the handle is pulled, according to certain other embodiments.

FIG. 20 illustrates a cross-sectional view along line D-D of FIG. 21.

FIG. 21 illustrates one implementation of a valve-interface, according to an alternate embodiment.

FIG. 22 shows a partial view of a drawer 2200 in perspective.

FIG. 23 illustrates a cross sectional view another embodiment of a spice rack that includes a vacuum reservoir.

FIG. 24 illustrates a cross sectional view another embodiment of a spice rack that includes a motor module.

FIG. 25 illustrates an embodiment of a valve-interface and corresponding valve used for connecting a compartment of a spice rack with the evacuating system for evacuating gasses from the compartment.

FIG. 26 illustrates another embodiment of a valve-interface and corresponding valve used for connecting a compartment of a spice rack with the evacuating system for evacuating gasses from the compartment.

FIG. 27 illustrates yet another embodiment of a valve-interface and corresponding valve used for connecting a compartment of a spice rack with the evacuating system for evacuating gasses from the compartment.

FIG. 28 illustrates another embodiment of a valve-interface and corresponding valve used for connecting a compartment of a spice rack with the evacuating system for evacuating gasses from the compartment.

FIG. 29 illustrates a sample modular design for modular compartments, according to certain embodiments of the invention.

FIG. 30 illustrates a rack, according to certain embodiments, that can be used in conjunction with the modular compartments.

### DETAILED DESCRIPTION

A method and apparatus for a vacuum packaging appliance spice rack accessory is illustrated and described. The invention may be embodied as an apparatus or a method. An apparatus within the spirit and scope of the invention may include a container with a cavity sized to receive a drawer, a drawer, and valves positioned to allow for evacuation of the container and the drawer. An apparatus within the spirit and scope of the invention may be used with a vacuum appliance or may be self-contained. A method within the spirit and scope of the present invention may include putting a drawer into a sealed container, evacuating the container, and opening the drawer without unsealing the rest of the container.

According to certain embodiments, an apparatus, used with a vacuum appliance, includes a manifold having a set of cavities sized to receive drawers, and having a set of valves. Each valve of the set of valves is set into a wall of the manifold between an internal cavity of the manifold and a cavity of the set of cavities. The apparatus also includes a set of drawers, each drawer sized to fit into a cavity of the set of cavities. Each drawer has a valve positioned to mate with the valve of a cavity of the set of cavities. The manifold further includes a back wall adjacent to the internal cavity, the back wall including a hose valve therethrough. The hose valve is formed to couple with a hose.

According to certain embodiments, the drawers may be of various sizes or the same size. The cavity that is to receive a given drawer is sized accordingly, such that the drawer substantially fills the cavity and seals an opening of the cavity. Further, the shape of the drawers may vary from implementation to implementation. The shape of the drawers may be adapted for ease in dispensing material contained in the drawer and/or the shape may be adapted for scooping material that is to be contained in the drawer. Further, according to certain embodiments, the drawers may be adapted to include labels that can be used for identifying the contents in a drawer. In certain implementations, the drawers may also include measurement markings for measuring the contents in the drawer or to aid in dispensing a desired amount of the contents from the drawer.

According to certain embodiments, a drawer may include a front panel for sealing the cavity that receives the drawer. The front panel can include a handle that is optionally adapted to vent the interior atmosphere of the drawer when the handle is pulled to pull the drawer out of the cavity.

According to certain other embodiments, an apparatus, used with a vacuum appliance, includes a first module including a manifold and a drawer. The manifold has a cavity sized to receive the drawer, and a set of valves, each valve of the set of valves set into a wall of the manifold between an internal cavity of the manifold and an exterior surface of the manifold. The manifold has a drawer valve, the drawer valve set into a wall between the cavity to receive the drawer and the internal cavity. The manifold has a hose valve, the hose valve set into an exterior wall of the manifold between the internal cavity and a back end of the manifold. The drawer is sized to fit into the cavity to receive the drawer. The drawer has a valve positioned to mate with the drawer valve of the manifold. The drawer is sized to fill the cavity substantially and to seal an opening of the cavity.

In another alternate embodiment, an apparatus for use with a vacuum appliance includes a means for holding food. The apparatus also includes a means for receiving the means for holding food. The apparatus further includes a means for evacuating the means for receiving and the means for holding.

In yet another alternate embodiment, a method of storing food includes filling a first drawer. The method also includes inserting the first drawer into a first cavity. The method further includes evacuating the first cavity and first drawer.

In still another alternate embodiment, an apparatus includes a manifold having a set of cavities sized to receive drawers, and having a set of valves. Each valve of the set of valves is set into a wall of the manifold between an internal cavity of the manifold and a cavity of the set of cavities. The apparatus further includes a set of drawers. Each drawer is sized to fit into a cavity of the set of cavities. Each drawer has a valve positioned to mate with the valve of a cavity of the set of cavities. The apparatus also includes a lower cavity below the manifold and the cavities to receive the drawers. The lower cavity is sealed off from the manifold, and is defined by walls contiguous with walls of the manifold and a bottom connected thereto. The apparatus further includes a vacuum pump housed in the lower cavity. Moreover, the apparatus includes a hose coupling the vacuum pump to the inner cavity of the manifold.

According to certain embodiments, the manifold having a set of cavities sized to receive drawers includes a pair of container-carriers with associated guide-tracks corresponding to each cavity of the set of cavities. The container-carriers and guide tracks corresponding to each cavity are adapted to allow a suitably sized container to slide in and out of the cavity while guided by the guide-tracks. According to certain implementations, such a container-carrier can include a mechanism for unsealing a vent or valve to a vacuum reservoir used for evacuating gases from a given container, if so desired. The guide track of the container-carrier can be adapted to be of various shapes.

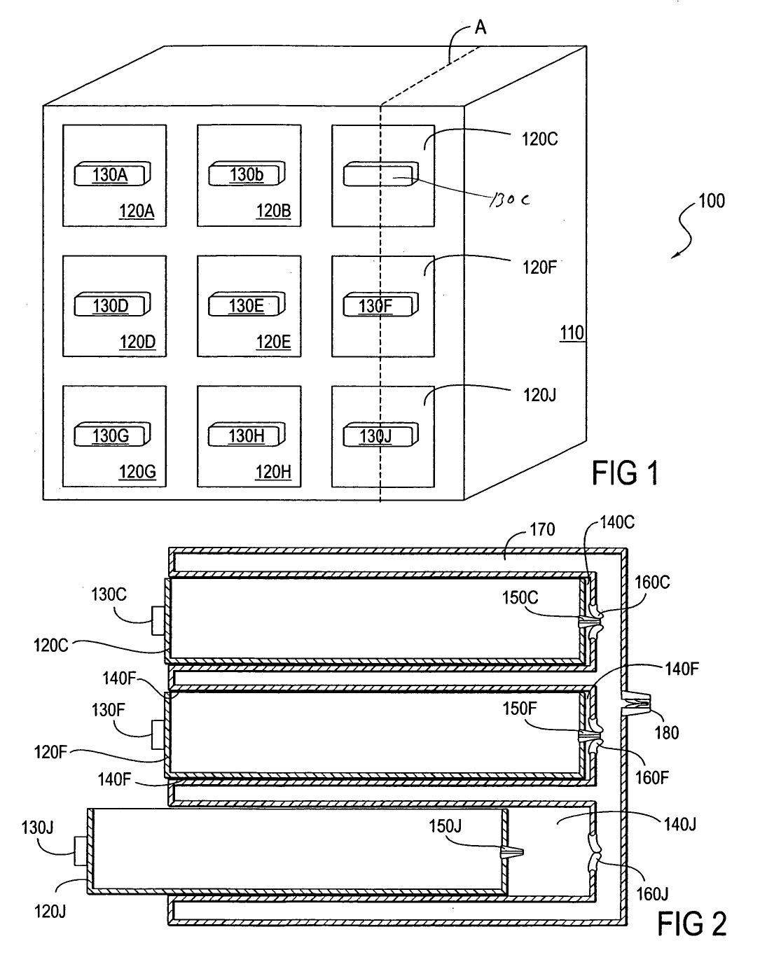

Turning to the embodiments illustrated, several embodiments of spice rack accessories or spice racks are illustrated. FIG. 1 illustrates an embodiment in perspective view of a spice rack that may be useful with a vacuum appliance. The embodiment includes a manifold cabinet in which drawers for spices may be stored and which has an external valve allowing for evacuation of the cabinet. Moreover, a system of valves allows a drawer to be removed from the cabinet without breaking the vacuum for the rest of the drawers.

In FIG. 1, drawers 120 (120A, 120B, 120C, 120D, 120E, 120F, 120G, 120H, 120J) are each housed in manifold 110 of spice rack accessory 100. Each drawer 120 has an external handle 130 (130A, 130B, 130C, 130D, 130E, 130F, 130G, 130H, 130J) suitable for use when pulling a drawer 120 out of cabinet 110. Line A illustrates a cut line for accessory 100.

FIG. 2 illustrates an embodiment in a cutaway view along line A of a spice rack that may be useful with a vacuum appliance. Each drawer 120 (including drawers 120C, 120F and 120J) includes a needle valve 150 (150C, 15OF and 150J). Each needle valve 150 may join with valves 160 (160C, 160F and 160J). Valves 160 allow communication between drawer cavities 140 (140C, 140F and 140J) and the manifold 170. However, valves 160 only allow such communication when the corresponding drawer 120 is fully inserted into its corresponding cavity 140, in which case the drawer is effectively sealed away from the external atmosphere. Under such circumstances, evacuating manifold 170 through valve 180 allows for evacuation of each cavity 140 containing a drawer 120.

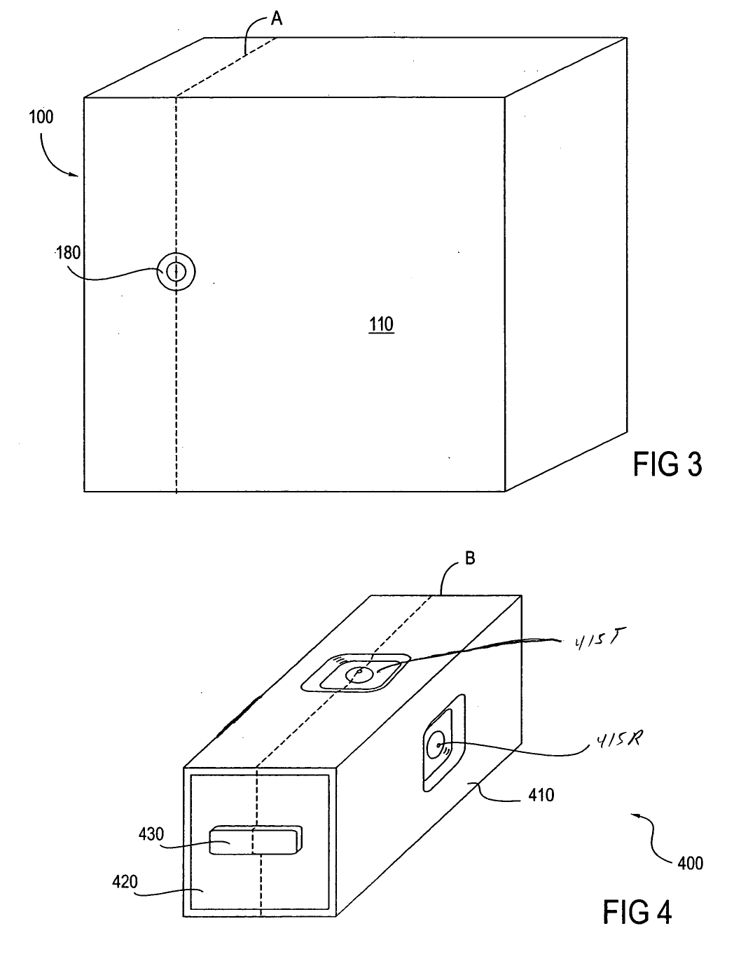

FIG. 3 illustrates an embodiment in a back view of a spice rack that may be useful with a vacuum appliance. Valve 180 is a one-way valve which may be connected to a tube, and thereby coupled to a vacuum pump. Consequently, cabinet 110 may be evacuated, along with any fully inserted drawers 120.

Another embodiment of a spice rack accessory is modular in nature. The module includes a housing and a drawer. The housing may be coupled to other housings through valves on each side of the housing, and may be evacuated through a valve in the back of the housing which is suitable for use with a tube coupled to a vacuum pump. FIG. 4 illustrates an alternate embodiment in a perspective view of a spice rack that may be useful with a vacuum appliance. Module 400 includes housing 410 and drawer 420. Drawer 420 includes handle 430 on its front face. Housing 410 includes valve 415T and valve 415R. Line B is a cut line through housing 410 and drawer 420.

FIG. 5 illustrates an alternate embodiment in a cutaway view along line B of a spice rack accessory that may be useful with a vacuum appliance. Housing 410 includes valve 460 which may be connected to a tube for use with a vacuum pump to evacuate housing 410 and drawer 420. Housing 410 also includes valve 415L and valve 415B. In one embodiment, valves 415T, 415R and 415B are ‘duckbill’ or similar one-way valves which may be penetrated by a needle valve 415L, such that multiple housings 410 may be connected by plugging a valve 415L into a valve 415T, 415R or 415B. Housing 410 also includes cavity (manifold) 470 and drawer cavity 440. Drawer cavity 440 also includes valve 455 which may communicate with cavity 470. Drawer 420 includes needle 450, which may mate with valve 455.

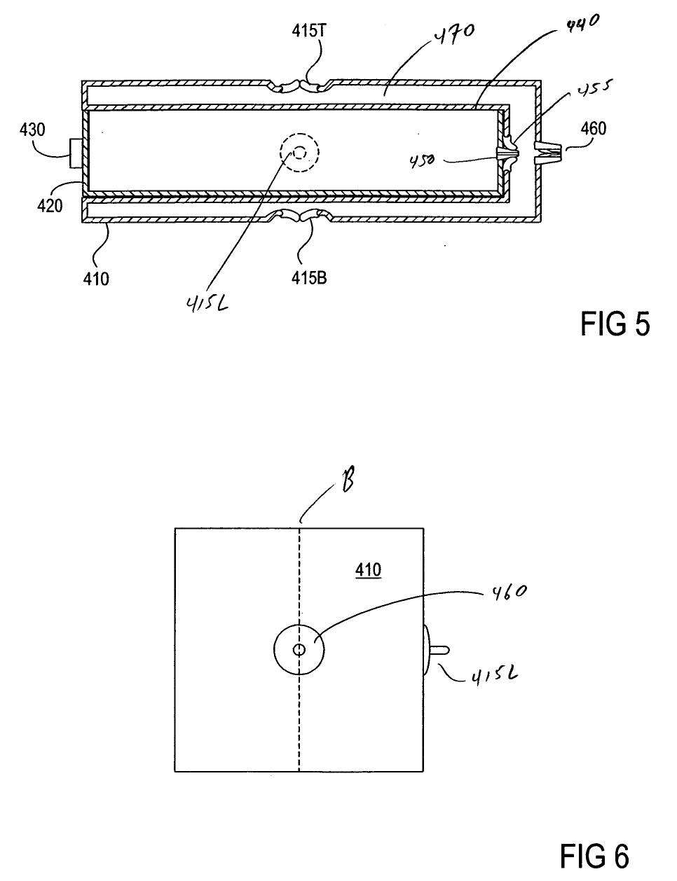

FIG. 6 illustrates an alternate embodiment in a back view of a spice rack, which may be useful with a vacuum appliance. As illustrated, valve 460 projects out of the back of container 410 and may be used to evacuate housing 410 using a tube or similar attachment. Moreover, needle valve 415L projects from the side of housing 410 and may be used to couple housing 410 to another module. Note that as described, one needle valve 415L of one module in a set of interconnected modules will need to be capped (such as by a valve cap for example) in order to preserve vacuum within the set of interconnected modules. Alternatively, a set of modules may be interconnected in a chain or loop, or a special module may be provided which only has duckbill style valves without a needle valve, for example.

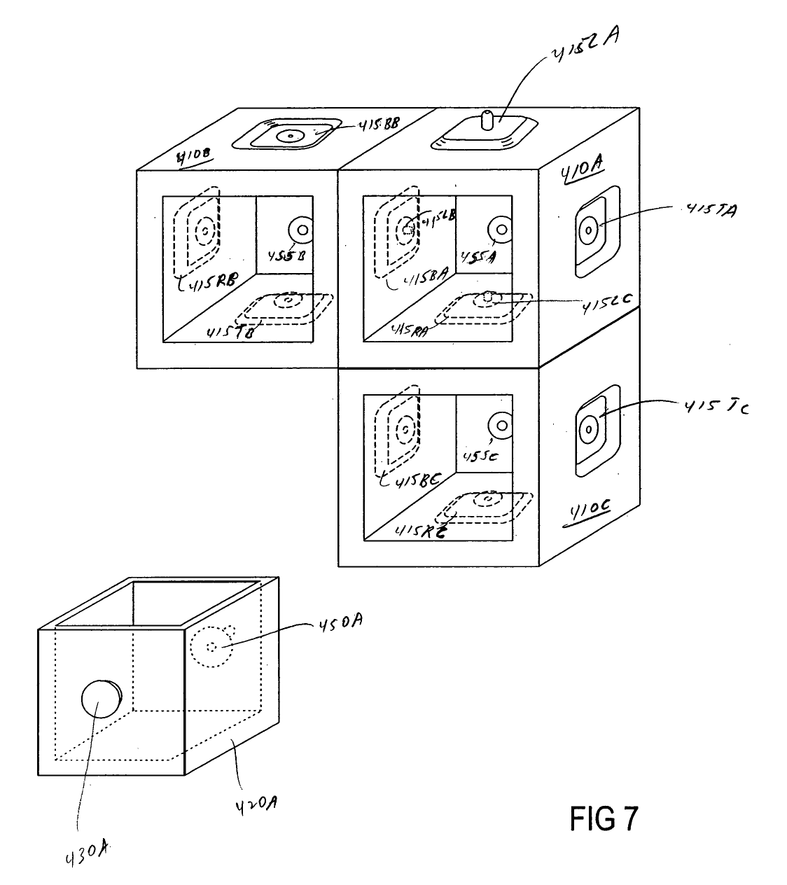

FIG. 7 illustrates an alternate embodiment of the spice rack of FIGS. 4-6 as it may be used. Housing 410A includes valves 415TA, 415RA and 415BA for coupling to needle valves of other housings and needle valve 415LA for coupling to valves of other housings. Housing 410A also includes a valve 455A between its internal cavity (not shown) and its drawer cavity. Needle valve 450A of drawer 420A may mate with valve 455A for example. Drawer 420A also includes handle 430A.

Coupled to housing 410A through valve 415BA and 415LB (needle valve) is housing 410B. Housing 410B also includes valves 415RB, 415TB and 415BB, along with valve 455B between its internal cavity (not shown) and its drawer cavity. Also coupled to housing 410A, through valve 415RA and 415LC (needle valve) is housing 410C. Housing 410C also includes valves 415RC, 415TC and 415BC, along with valve 455C between its internal cavity (not shown) and its drawer cavity. Each of housing 410A, 410B and 410C also include a valve on their back sides which may be coupled through a hose to a vacuum pump for purposes of evacuation. When drawers are inserted into each of housing 410A, 410B and 410C, those drawers may similarly be evacuated.

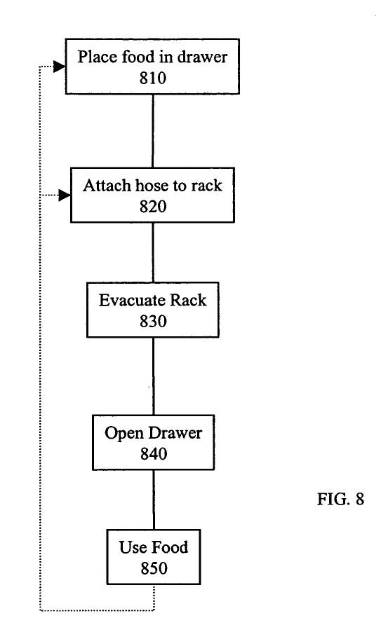

FIG. 8 illustrates an embodiment of a process of using a spice rack with a vacuum appliance. The process generally includes placing food in the rack, evacuating the rack, then later opening a desired drawer in the rack and using the food, optionally allowing for either refilling the opened portion of the rack or simply evacuating the rack again. At block 810, food is placed in a drawer in the rack, and the drawer is closed, thereby providing an essentially airtight seal. At block 820, a hose is attached to the rack, thereby coupling the rack to a vacuum pump. At block 830, the rack is evacuated using the vacuum pump, such as a vacuum pump in a vacuum appliance. At block 840, when access to food is desired, the drawer containing the desire food is opened, thereby breaking vacuum for that drawer but not for the rest of the spice rack. At block 850, the food in the drawer is used, and the drawer is then closed to reseal the rack. As illustrated, the process may then loop back to block 810 (refilling the drawer for example) or block 820 (attaching the hose to the rack for example). Alternatively, the process may loop back to block 840 (opening another drawer for example) or block 830 (evacuating using a previously attached hose for example).

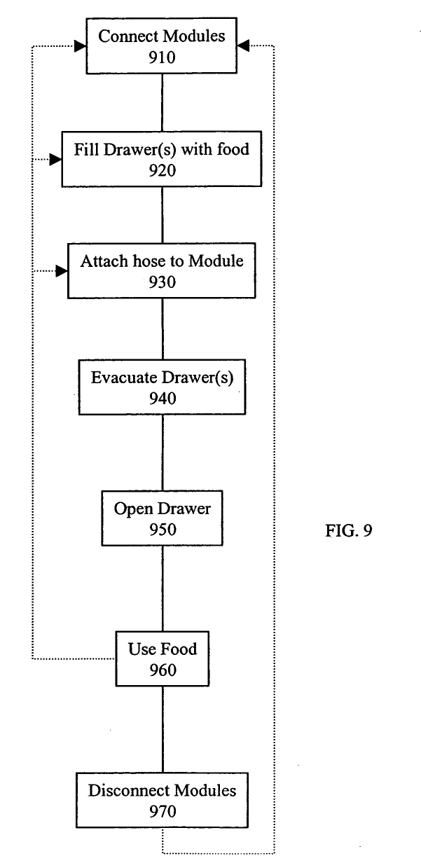

FIG. 9 illustrates an alternate embodiment of a process of using a spice rack with a vacuum appliance. The process includes connecting or coupling modules to form a spice rack of a desired shape, filling the drawers of the modules with food, evacuating the modules, later accessing a desired drawer and food contained therein to use the food, and eventually disconnecting one or more modules. At block 910, modules of a set of modules are connected or coupled, or modules are added to a previously assembled set of modules. At block 920, drawers of the modules are filled (partially or completely) with food. At block 930, a hose is attached to a module of the set of modules through a valve, thereby coupling the modules to a vacuum pump, such as a vacuum pump in a vacuum appliance. At block 940, the drawers and modules are evacuated using the vacuum pump.

At block 950, at a later time, a drawer is opened, thereby unsealing that drawer without unsealing the other drawers of the spice rack. At block 960, the food of the drawer is used and the drawer is closed again to reseal the spice rack. At block 960, the process may loop back to block 910 (connect more modules), 920 (fill the drawer with food), or 930 (attach the hose to the spice rack again). Moreover, other drawers may be opened (block 950) or the spice rack may be evacuated again using a previously attached hose (block 940). From block 960, the process may proceed to block 970, and the modules may be disconnected if that is desired, too.

Preferably, the spice racks of FIGS. 1-3 and of FIGS. 4-7 are used with a vacuum appliance having a hose suitable for use with the valves depicted. FIG. 12 illustrates an embodiment of a vacuum appliance, which may include a vacuum hose and which may be used with a spice rack accessory such as those described above. In particular, FIG. 12 shows a perspective view of an embodiment of a vacuum appliance 20. Buttons 66 and 68 respectively are provided on appliance 20 to activate a vacuum pump and a heat sealing wire. Indicators 56 and 57 are provided to indicate when either vacuum or heat sealing is occurring respectively. In such an embodiment, vacuum hose 85 may be used with opening or valve 86 to couple the vacuum pump of appliance 20 to a valve on another device, such as a jar or spice rack, or a lid for a jar. FIG. 13 illustrates a back perspective view of an embodiment of appliance 20, utilizing another valve 86 connected to hose 85, which is optionally coupled to device 20 through use of clamps or brackets 90 and 95.

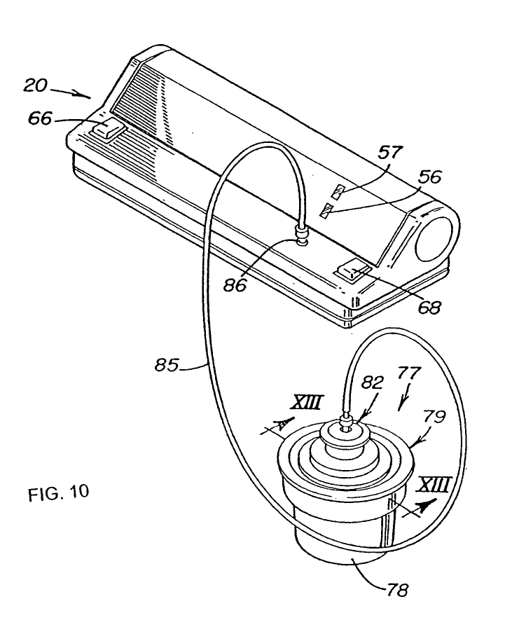

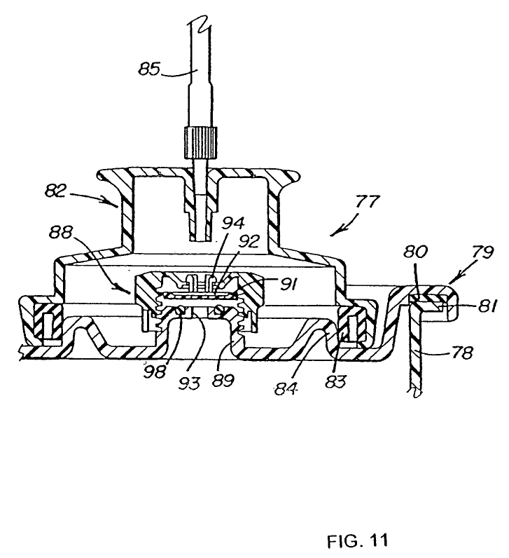

FIGS. 10 and 11 illustrate a lid attachment 77 for a container 78 adapted for connection to a vacuum pump of apparatus 20 for selectively evacuating the container. The lid attachment includes an annular lid adapter 79 and an annular elastomeric seal 80 secured thereunder to form a static seal at an upper flange 81 of container 78. The lid attachment further comprises an annular connector 82 having an annular elastomeric seal 83 secured thereunder to engage a radially outer surface of an annular ridge 84 formed on lid adapter 79. A flexible plastic tube 85 is attached between connector 82 and an opening or connector 86, formed through the top panel of appliance 20 (FIG. 10). Connector 86 may be used to provide a connection or coupling between tube or hose 85 and the vacuum pump of appliance 20.

Referring to FIG. 11, a thumbnut 88 is threaded onto a neck 89, formed centrally on lid adapter 79. An indicia marking in the form of an arrow may be formed on the thumb-nut to visually indicate one of three operative positions of the thumb-nut, i.e., “vacuum”, “closed”, or “open” on lid adapter 79.

In particular, a plastic disc 91 is “loosely” mounted within thumbnut 88 and forms a valve element that openly communicates the vacuum drawn in tube 85 (FIGS. 10 and 11) with the container. The vacuum is drawn across a transverse slot 92 formed in the upper surface of the disc and through a centrally disposed passage 93, formed through neck 89. The applied vacuum will induce a lifting of disc 91, which overlies passage 93, to aid in evacuation.

A plurality of radially and circumferentially spaced hook-like fingers or retention members 94 are formed integrally with the disc in upstanding relationship thereon to extend through a mounting hole and may overlie a flange defined on the thumb-nut for retention purposes. The retention members are sufficiently flexible and resilient to permit a snapping-out of the members from their mounting hole, formed centrally through the thumbnut. Such a valve may be adapted for use with the spice rack accessory, allowing for coupling of a vacuum appliance or apparatus to the spice rack through use of a tube such as tube 85.

FIG. 14 illustrates an alternate embodiment in a perspective view of a spice rack with a vacuum capability. The embodiment includes a manifold cabinet in which drawers for spices may be stored and which has an external valve allowing for evacuation of the cabinet. Moreover, a system of valves allows a drawer to be removed from the cabinet without breaking the vacuum for the rest of the drawers.

In FIG. 14, drawers 1250 are each housed in manifold 1210 of spice rack accessory 1200 and may contain a substance 1270 for example. Each drawer 1250 has an external handle suitable for use when pulling a drawer 1250 out of manifold 1210. Valves such as valve 1230 are activate only when container 1250 occupies its corresponding space, thereby allowing for evacuation without breaking vacuum if a drawer is removed. Seal 1240 provides a seal against the external atmosphere when drawer 1250 is placed in manifold 1210. Manifold 1210 includes lid 1220 which is effectively a lid for each drawer 1250.

In the embodiment illustrated, manifold 1210 includes vacuum pump 1260 therein, which allows for evacuation of accessory 1200 using an internal pump which pumps down manifold 1210 and thereby evacuates each inserted container 1250. Alternatively, a separate cavity may be formed below manifold 1210, in which vacuum pump 1260 may be stored. Pump 1260 may be coupled to manifold 1210 through use of a tube communicating with manifold 1210.

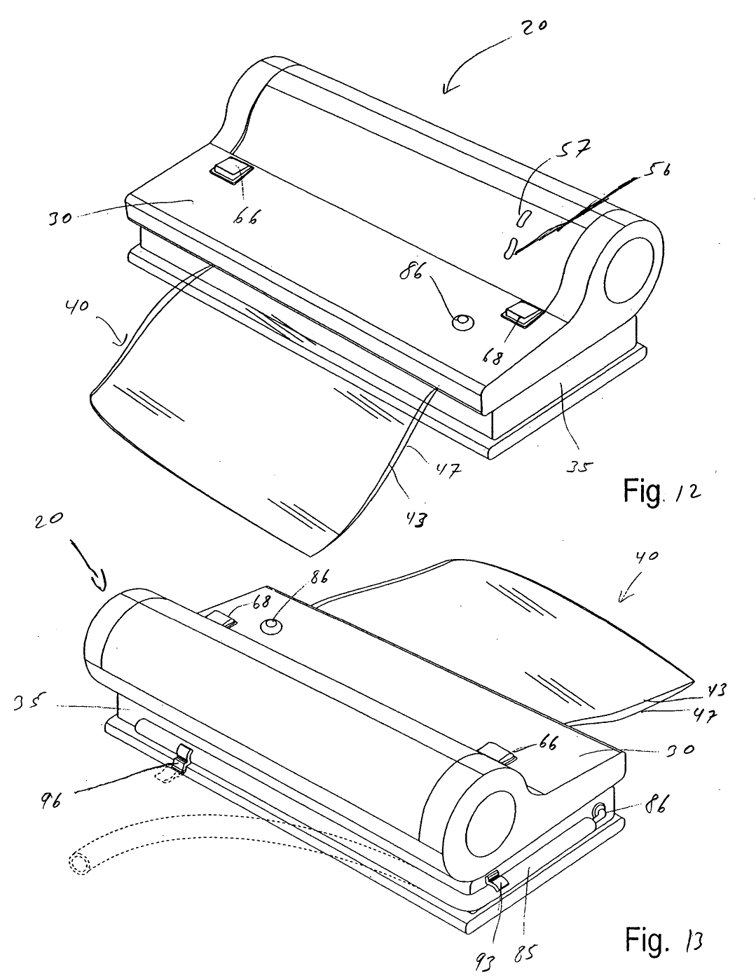

FIG. 15 illustrates a frontal view of an alternate embodiment of a spice rack having drawers of various sizes. The embodiment includes a cabinet 1500 having three sizes of drawers such as drawers 1502, 1504, and 1505, for example. Drawer 1502 is one-third the size of drawer 1504 and one-sixth the size of drawer 1505. The embodiments are not limited to three sizes of drawers and thus the number of sizes may vary from implementation to implementation.

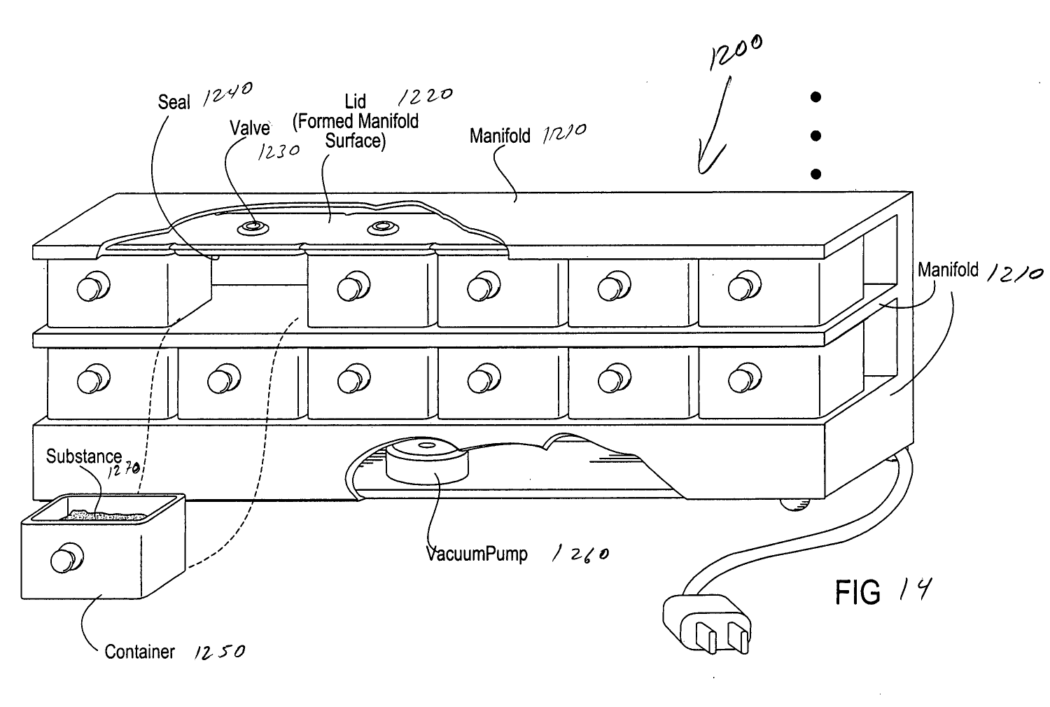

FIG. 16 illustrates a container or drawer having a shape that is adapted for ease in refilling or dispensing material stored in the drawer and/or the shape may be adapted for scooping material that is to be contained in the drawer, according to certain embodiments. FIG. 16 shows a scoop-shaped drawer 1600 that includes measurement markings 1602 for measuring the contents in the drawer or to aid in dispensing a desired amount of the contents from the drawer. The embodiments are not limited to any particular drawer shape and thus, the drawer shape may vary from implementation to implementation. According to certain other embodiments, drawer 1600 may include a measuring spoon that is detachably affixed to drawer 1600.

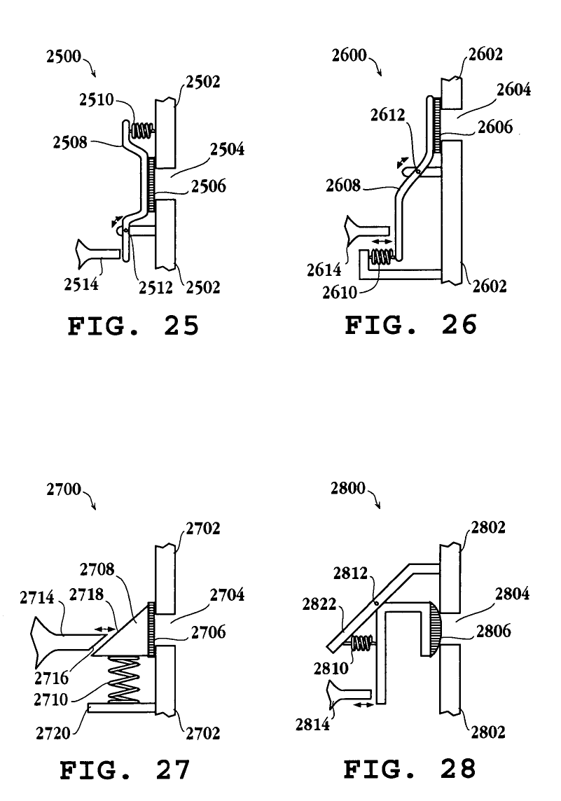

FIG. 17 illustrates one of the compartments of an alternate embodiment that includes a multi-compartment cabinet and a plurality of containers. The plurality of containers can be inserted in the various compartments of the cabinet using a series of container carriers and associated guide-tracks. FIG. 17 is cross-sectional view of a container and corresponding compartment in the multi-compartment cabinet. In FIG. 17, compartment 1700 includes walls 1722 (1722a, 1722b, 1722c, 1722d not shown, 1722e not shown) that surround a cavity 1724c on five sides. Compartment 1700 can be sealed by front-panel 1704. Front-panel 1704 includes a seal gasket 1706, a handle 1702, a vent 1726 and a sealing plate 1718 over vent 1726. FIG. 17 also shows a compression spring 1716 which in conjunction with a back-stop 1728 is adapted to keep sealing plate 1718 in a sealed position over vent 1726, when compression spring 1716 is in a substantially undeformed state, i.e., when no pulling force is applied to handle 1702. Compartment 1700 further includes a pair of container carriers 1708. Each container carrier includes a guide track 1710 and a valve-interface 1714. Container 1712 can be inserted into compartment 1700 using container carriers 1708 by sliding the sides of the container along guide tracks 1710. According to certain embodiments, front-panel 1704 may be attached to the guide tracks in a manner that allows for front-panel 1704 to be slidably positioned away from the compartment 1700 in order to insert container 1712 into compartment 1700. Front-panel 1704 would also be slidably positioned to seal compartment 1700 as in a closed position. In certain other embodiments, front-panel 1704 may be attached to container 1712. One implementation of container carriers and associated guide tracks is described herein with reference to FIG. 20. Valve-interface 1714 may vary from implementation to implementation. Some examples of valve-interfaces are described herein with reference to FIG. 21, FIG. 25, FIG. 26, FIG. 27, and FIG. 28. Container 1712 may be of a shape that is adapted for scooping material that is to be contained in the container. Further, container 1712 can be scoop-shaped and include measurement markings for measuring the contents in the container or to aid in dispensing a desired amount of the contents from the container. The embodiments are not limited to any particular container shape and thus, the container shape may vary from implementation to implementation. The container may be dish-washable and may be made of a material that is different from that of the cabinet. For example, since the container surface is subject to uniform pressure, the container may be made of a material that is less strong than the material of the cabinet. In certain embodiments, the container may a disposable-type container for ease of replacement.

According to certain embodiments, a drawer may include a front panel for sealing the cavity that receives the drawer. The front panel can include a handle that is optionally adapted to vent the interior atmosphere of the drawer when the handle is pulled to pull the drawer out of the cavity. The venting of the interior atmosphere of the drawer allows for the drawer to be pulled out of the cavity with relative ease. If the interior atmosphere remains unvented, the vacuum seal makes it difficult to pull the drawer out of the cavity due to the difference in pressure between the exterior and interior of the drawer.

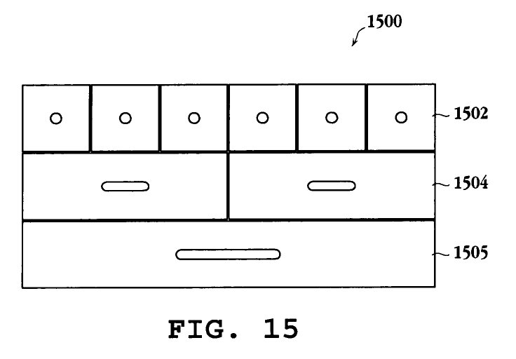

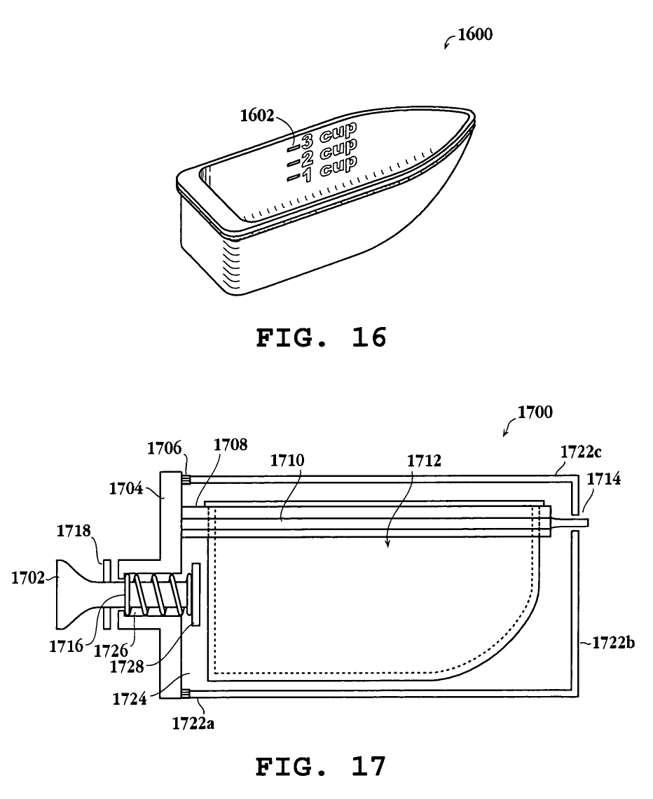

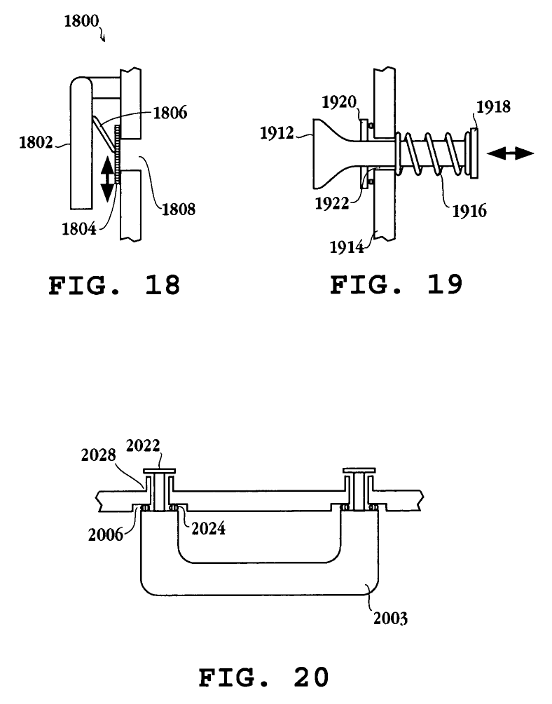

FIG. 18 illustrates a drawer handle that is adapted to vent the interior atmosphere of the drawer when the handle is pulled, according to certain embodiments. FIG. 18 shows a handle 1802 attached to drawer front-panel 1800. Additionally, handle 1802 attached to a rod 1806 that is in turn attached to a sealing plate 1804. Sealing plate 1804 is for sealing vent 1808 when handle 1802 is resting in a position that is substantially parallel to the plane of drawer front-panel 1800. When handle 1802 is pulled in a direction tending to pull the drawer out of its corresponding cavity, sealing plate 1804 is lifted to unseal vent 1808 to expose the internal atmosphere of the drawer to ambient atmosphere.

FIG. 19 illustrates a drawer handle is adapted to vent the interior atmosphere of the drawer when the handle is pulled, according to another embodiment. FIG. 19 shows a drawer front-panel 1914, a drawer handle that includes a knob 1912 at one end of the drawer, a sealing plate 1920, a vent 1933, a compression spring 1916, and a back-stop 1918. Back-stop 1918 is attached to the drawer handle at the opposite end to knob 1912. Compression spring 1916 in conjunction with back-stop 1918 is adapted to keep sealing plate 1920 in a sealed position over vent 1922, when compression spring 1916 is in a substantially undeformed state, i.e., when no pulling force is applied to knob 1912. When knob 1912 is pulled in a direction tending to pull the drawer out of its corresponding cavity, sealing plate 1920 is lifted to unseal vent 1922 to expose the internal atmosphere of the drawer to ambient atmosphere.

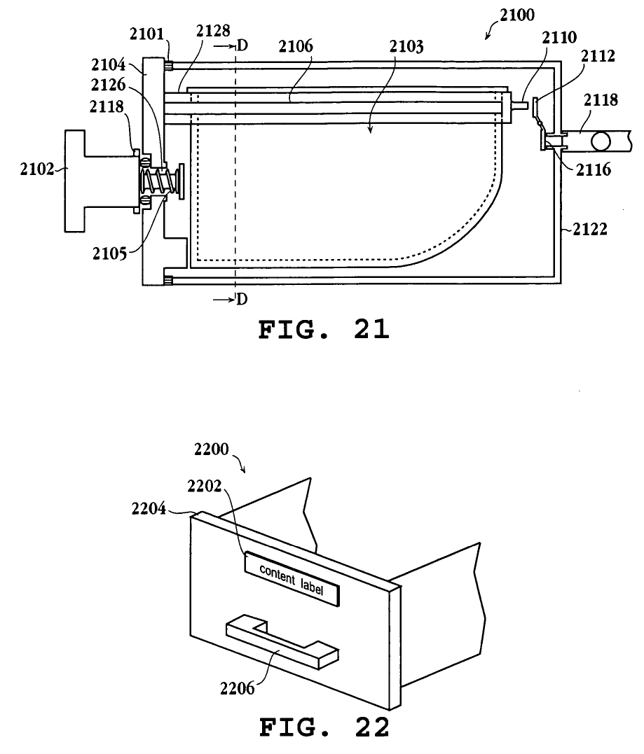

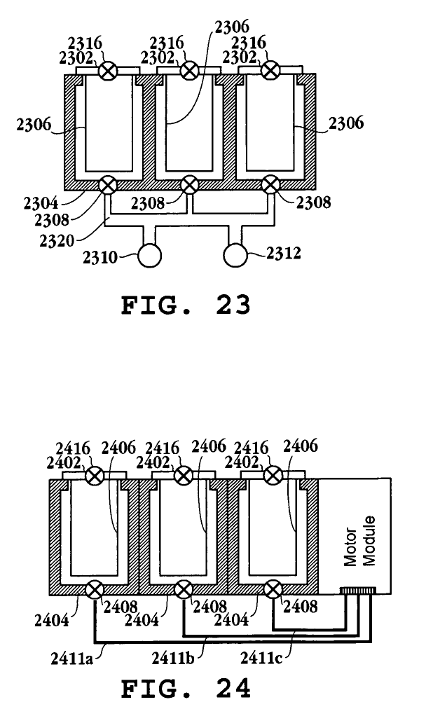

FIG. 21 illustrates one implementation of a valve-interface according to certain embodiments. In FIG. 21, compartment 2100 includes walls 2122, front-panel 2104, a seal gasket 2101, a handle 2102, a vent 2126, and a sealing plate 2118 over vent 2126, and compression spring 2105. Compartment 2100 also includes a container carrier 2128 and an associated guide track 2106 for carrying container 2103. Attached to the container carrier is a valve interface 2110. Valve-interface 2110 is adapted to unseal valve 2116 when valve-interface 2110 pushes on one end of lever 2112. Valve 2116 is in communication with a gas evacuation system through communication channel 2118. Valve-interface 2110 pushes on one end of lever 2112 in order to unseal valve 2116 when front-panel 2104 is flush against wall 2122 of compartment 2100. Thus, the interior of compartment 2100 is in communication with the gas evacuation system when front-panel 2104 is in the sealed position for sealing compartment 2100. According to certain embodiments, it is desirable that the interior of compartment 2100 be in communication with the evacuation system in order to monitor and maintain the atmosphere in the interior of compartment 2100. The monitoring and maintenance of the atmosphere in the interior of a compartment is further described herein with reference to FIG. 23. An embodiment of the evacuation system is described herein with reference to FIG. 24.

Further, according to certain embodiments, the spice rack drawers may be adapted to include labels that can be used for providing information related to the contents in a drawer. FIG. 22 shows a partial view of a drawer 2200 in perspective. Drawer 2200 includes a front-panel 2204. Front-panel 2204 includes a label 2202 and a drawer handle 2206. Label 2202 may be used to indicate the contents of the drawer and/or to indicate an expiration date, for example.

FIG. 20 illustrates a cross-sectional view along line D-D of FIG. 21. FIG. 20 shows container carrier 2028 with associated guide-track 2006. Container 2003 includes a hanger section 2022 that hangs in guide-track 2006. Guide-track 2006 may optionally include a series of ball-bearings or rollers 2024 along the length of guide track 2006 to facilitate the gliding of container 2003 in and out of guide-track 2006.

FIG. 23 illustrates a cross sectional view another embodiment of a spice rack that includes a vacuum reservoir. FIG. 23 shows a cross sectional view of one row of compartments 2304 in the spice rack. The spice rack may include any number of rows and columns of compartments. A container 2306 can be inserted into each compartment. FIG. 23 also shows a front-panel 2302 that includes a vent mechanism 2316. Front-panel 2302 can be attached to container 2306 or to guide tracks (not shown) associated with compartment 2304. FIG. 23 also shows an evacuation system for evacuating gases from compartments 2304. Each compartment 2304 is adapted for communication with the evacuation system through a suitable valve 2308. Each valve 2308 is in communication with a vacuum reservoir 2320, a vacuum sensor 2310 and a vacuum motor 2312. Such an evacuation system may be integral part of the spice rack according to some embodiments. According to some other embodiments, the spice rack is separate from the evacuation system but is adapted for use with the evacuation system.

According to certain embodiments, each compartment 2304 and the container 2306 therein is vented to the vacuum reservoir 2320 when compartment 2304 is in the closed position sealed by front-panel 2302. When a compartment is in the open position, valve 2308 is caused to be sealed in order to isolate the open compartment so as to not break the vacuum that is existing in the other closed and previously gas evacuated compartments. The sealing and unsealing of valves that vent to a vacuum reservoir are further described herein with reference to FIGS. 25-28.

Vacuum sensor 2310 is used for detecting the vacuum level in the reservoir which is also the vacuum level of those compartments that have not been isolated from the vacuum reservoir (i.e., compartments in the closed position). According to certain embodiments, a desired vacuum level can be maintained by activating the gas-evacuation procedure whenever the vacuum level falls below the desired vacuum level. The vacuum level in the compartments can change due to natural phenomena such as out-gassing from materials stored in the compartments. For example, food products tend to emit gases over time. Further, the vacuum reservoir helps in controlling odor and humidity. The vacuum reservoir prevents back-flow of gases into the compartments thus avoiding intermingling of odors from the different compartments in the spice rack.

FIG. 24 illustrates a cross sectional view another embodiment of a spice rack that includes a motor module. FIG. 24 shows a cross sectional view of one row of compartments 2404 in the spice rack. The spice rack may include any number of rows and columns of compartments. A container 2406 can be inserted into each compartment. FIG. 24 also shows a front-panel 2402 that includes a vent mechanism 2416. Front-panel 2402 can be attached to container 2406 or to guide tracks (not shown) associated with compartment 2404. FIG. 24 also shows a motor module 2412 that includes a vacuum pump for evacuating gases from compartments 2404. Each compartment is connected to motor module 2412 through connecting tubes 2411 (2411a, 2411b, 2411c). One end of connecting tube 2411 is connected to valve 2408 and the other end of connecting tube 2411 is connected to motor module 2412.

FIG. 25 illustrates an embodiment of a valve-interface and corresponding valve used for connecting a compartment of a spice rack with an evacuating system for evacuating gasses from the compartment. FIG. 25 shows valve-interface 2514 and valve 2500. Valve 2500 includes a lever 2508 with attached gasket 2506 for sealing vent hole 2504. One end of lever 2508 is hinged at hinge 2512. The other end of lever 2508 is restrained by a spring 2510 attached to a back wall 2502 of the spice rack compartment. When the compartment is in the closed position, valve-interface 2514 impinges upon lever 2508 at the hinged portion of lever 2508 to cause lever 2508 to pull away from back wall 2502 and to unseal vent hole 2504. When the compartment is in the open position, valve-interface 2514 ceases to impinge upon lever 2508. When valve-interface 2514 ceases to impinge upon lever 2508, spring 2510 restores lever 2508 to its original unimpinged position, thus sealing vent hole 2504. In other words, the spring 2710 extends to its unloaded position.

FIG. 26 illustrates another embodiment of a valve-interface and corresponding valve used for connecting a compartment of a spice rack with an evacuating system for evacuating gasses from the compartment. FIG. 26 shows valve-interface 2614 and valve 2600. Valve 2600 includes a lever 2608 with attached gasket 2606 for sealing vent hole 2604. Lever 2608 is hinged at hinge 2612. The hinge location is located at approximately one third the length of lever 2608. Gasket 2602 is attached to one end of lever 2608. The other end of lever 2608 is attached to a spring 2610. When the compartment is in the closed position, valve-interface 2614 impinges upon lever 2608 near the hinged portion of lever 2608 to cause lever 2608 to pull away from back wall 2602 and to unseal vent hole 2604. When the compartment is in the open position, valve-interface 2614 ceases to impinge upon lever 2608. When valve-interface 2614 ceases to impinge upon lever 2608, spring 2610 restores lever 2608 to its original unimpinged position, thus sealing vent hole 2604.

FIG. 27 illustrates yet another embodiment of a valve-interface and corresponding valve used for connecting a compartment of a spice rack with the evacuating system for evacuating gasses from the compartment. FIG. 27 shows valve-interface 2714 and valve 2700. Valve-interface 2714 is adapted to have an inclined edge 2716. Valve 2700 includes a cam piece 2708 with attached gasket 2706 for sealing vent hole 2704. Cam piece 2708 is spring loaded by spring 2710 that has one end attached to cam piece 2708 and the other end attached to a shaft 2720. Shaft 2720 is attached to back wall 2702. When the compartment is in the closed position, edge 2716 of valve-interface 2714 impinges upon an inclined edge 2718 of cam piece 2708 to cause cam piece 2708 to slide towards shaft 2720 to unseal vent hole 2704. When the compartment is in the open position, valve-interface 2714 ceases to impinge cam piece 2708. When valve-interface 2714 ceases to impinge upon cam piece 2708, spring 2710 restores cam piece 2708 to its original unimpinged position, thus sealing vent hole 2604, once again.

FIG. 28 illustrates another embodiment of a valve-interface and corresponding valve used for connecting a compartment of a spice rack with the evacuating system for evacuating gasses from the compartment. FIG. 28 shows valve-interface 2814 and valve 2800. Valve 2800 includes an angled structural element 2820. Angled structural element 2820 is rotatably hinged at 2812 to a supporting angled post 2822. In addition, angled structural element 2820 is attached to supporting angled post 2822 by a spring 2810. Angled structural element 2820 includes a rounded gasket 2806 for sealing vent hole 2804. Supporting angled post 2822 is attached to back wall 2002 at one end of angled post 2822. When the compartment is in the closed position, valve-interface 2814 impinges upon angled structural element 2820 to cause angled structural element 2820 to rotate away from back wall 2802 to unseal vent hole 2804. When the compartment is in the open position, valve-interface 2814 ceases to impinge upon angled structural element 2820. When valve-interface 2814 ceases to impinge upon angled structural element 2820, spring 2810 restores angled structural element 2820 to its original unimpinged position, thus sealing vent hole 2804.

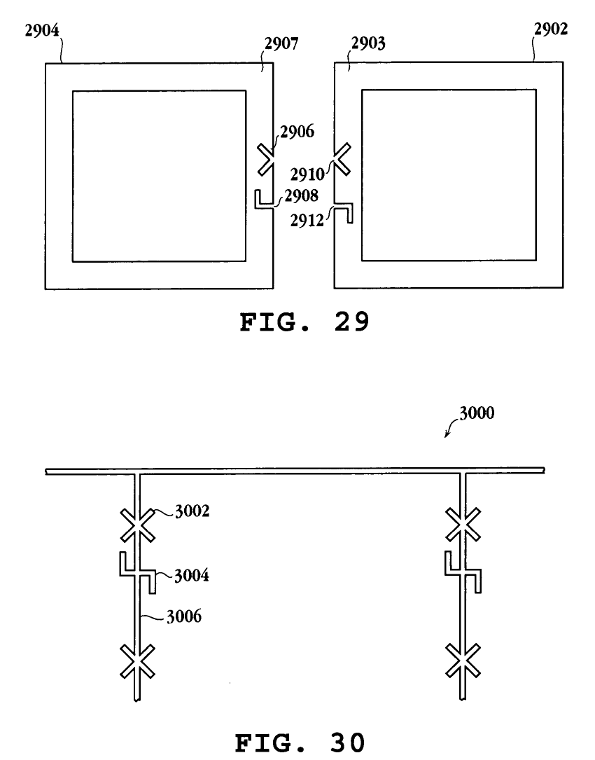

FIG. 29 illustrates a sample modular design for modular compartments, according to certain embodiments of the invention. FIG. 29 shows a top view of modular compartments 2902 and 2904. Modular compartment 2902 has slots 2910 and 2912 along compartment wall 2903. Similarly, modular compartment 2904 has slots 2906 and 2908 along compartment wall 2907. The embodiments are not limited to any particular shaped slots. The shape of the slots may vary from implementation to implementation. Modular compartments can be grouped to form a cabinet by using a rack as described herein with reference to FIG. 30. Such a rack would include the male counterpart components that would fit into slots 2906, 2908, 2910 and 2912. FIG. 29 shows two modular compartments. However, a cabinet can be composed of any number of modular compartments as is desired.

FIG. 30 illustrates a rack, according to certain embodiments, that can be used in conjunction with the modular compartments previously described. FIG. 30 shows a rack 3000 that includes male counterpart fittings that would fit into slots of modular compartments, such as slots 2906, 2908, 2910 and 2912, for example. In FIG. 30, rack 3000 includes fittings such as fittings 3002 and 3004, for example, on rail 3006. Thus, one modular compartment, such as compartment 2904, can be fitted onto the left half of fittings 3002 and 3004. Similarly, a modular compartment, such as compartment 2902, can be fitted onto the right half of fittings 3002 and 3004.

From the foregoing, it will be appreciated that specific embodiments of the invention have been described herein for purposes of illustration, but that various modifications may be made without deviating from the spirit and scope of the invention. In some instances, reference has been made to characteristics likely to be present in various or some embodiments, but these characteristics are also not necessarily limiting on the spirit and scope of the invention. In the illustrations and description, structures have been provided which may be formed or assembled in other ways within the spirit and scope of the invention. As an example, specific types of valves are mentioned in some of the embodiments illustrated, but many other types of valves may be appropriate for substitution within these embodiments without departing from the spirit and scope of the present invention. Similarly, methods have been illustrated and described as linear processes, but such methods may have operations reordered or implemented in parallel within the spirit and scope of the invention. Accordingly, the invention is not limited except as by the appended claims.

1. An apparatus for use with a vacuum appliance, comprising:
a manifold having a set of cavities sized to receive drawers, and having a set of valves, each valve of the set of valves set into a wall of the manifold between an internal cavity of the manifold and a cavity of the set of cavities;
a set of drawers, each drawer sized to fit into a cavity of the set of cavities, each drawer having a valve positioned to mate with the valve of a cavity of the set of cavities; and
wherein the manifold further includes a back wall adjacent to the internal cavity, the back wall including a hose valve therethrough, the hose valve formed to couple with a hose.

2. The apparatus of claim 1, wherein each drawer of the set of drawers further includes a handle.

3. The apparatus of claim 1, wherein each valve of the set of drawers is a needle valve.

4. The apparatus of claim 3, wherein each valve of the set of cavities is a duckbill valve.

5. The apparatus of claim 4, wherein each drawer includes a bottom, a left side wall, a right side wall, a back wall and a front wall, the front wall having a handle mounted thereon, the back wall having the needle valve therethrough.

6. An apparatus for use with a vacuum appliance, comprising:
a first module including a manifold and a drawer;
the manifold having a cavity sized to receive the drawer, and having a set of valves, each valve of the set of valves set into a wall of the manifold between an internal cavity of the manifold and an exterior surface of the manifold, the manifold having a drawer valve, the drawer valve set into a wall between the cavity to receive the drawer and the internal cavity, the manifold having a hose valve, the hose valve set into an exterior wall of the manifold between the internal cavity and a back end of the manifold; and
the drawer sized to fit into the cavity to receive the drawer, the drawer having a valve positioned to mate with the drawer valve of the manifold, the drawer sized to fill the cavity and to seal an opening of the cavity.

7. The apparatus of claim 6, wherein the set of valves includes three female valves and one male valve.

8. The apparatus of claim 7, further comprising:
a second module including a manifold and a drawer;
the manifold of the second module having a cavity sized to receive the drawer, and having a set of valves, each valve of the set of valves set into a wall of the manifold of the second module between an internal cavity of the manifold of the second module and an exterior surface of the manifold of the second module, the manifold of the second module having a drawer valve, the drawer valve set into a wall between the cavity to receive the drawer and the internal cavity, the manifold of the second module having a hose valve, the hose valve set into an exterior wall of the manifold of the second module between the internal cavity and a back end of the manifold of the second module, the set of valves of the manifold of the second module including a male valve, the needle valve of the second module connected to one of the female valves of the first module; and
the drawer of the second module sized to fit into the cavity to receive the drawer of the second module, the drawer of the second module having a valve positioned to mate with the drawer valve of the manifold of the second module, the drawer of the second module sized to fill the cavity of the second module and to seal an opening of the cavity of the second module.

9. An apparatus, comprising:
a manifold having a set of cavities sized to receive drawers, and having a set of valves, each valve of the set of valves set into a wall of the manifold between an internal cavity of the manifold and a cavity of the set of cavities;
a set of drawers, each drawer sized to fit into a cavity of the set of cavities, each drawer having a valve positioned to mate with the valve of the manifold of a cavity of the set of cavities;
a lower cavity below the manifold and the cavities to receive the drawers, the lower cavity sealed off from the manifold, the lower cavity defined by walls contiguous with walls of the manifold and a bottom connected thereto;
a vacuum pump housed in the lower cavity; and
a hose coupling the vacuum pump to the inner cavity of the manifold.

10. An apparatus for use with a vacuum appliance, comprising:
means for holding food;
means for receiving the means for holding food; and
means for evacuating the means for receiving and the means for holding.

11. An apparatus, comprising:
a manifold having a set of compartments, each compartment of said set of compartments is sized to receive a container;
an evacuation system for evacuating gasses from said compartments;
wherein each compartment of said set of compartments includes a container carrier for carrying said container, and a valve for interfacing with said evacuation system.

12. The apparatus of claim 11, wherein said evacuation system includes a vacuum reservoir and said each compartment is in communication with said vacuum reservoir when said each compartment is sealed from an ambient atmosphere that is external to said manifold by shutting said each compartment.

13. The apparatus of claim 12, wherein said each compartment includes a valve interface for opening said valve when said each compartment is in a shut position.

14. The apparatus of claim 12, wherein said evacuation system includes a vacuum sensor for sensing a vacuum level of said vacuum reservoir and said evacuation system being adapted for automatically evacuating gases if said vacuum level falls below a pre-determined level.

15. The apparatus of claim 11, wherein said each compartment includes a sealing front-panel for sealing said each compartment from an ambient atmosphere that is external to said manifold.

16. The apparatus of claim 15, wherein said sealing front-panel includes a handle for opening said each compartment, wherein said handle includes venting mechanism for venting said each compartment.

17. The apparatus of claim 11, wherein said container carrier includes a guide track for guiding said container as said container is pulled in and out of said each compartment for accessing contents in said container.

18. The apparatus of claim 11, wherein said container has a shape that is adapted for ease in refilling and dispensing content stored in said container.

19. The apparatus of claim 11, wherein said container includes measurement markings for measuring content stored in said container.

20. The apparatus of claim 11, wherein said container includes a measuring spoon wherein said measuring spoon is detachably affixed to said container.

21. A method of storing food, comprising:
filling a first drawer;
inserting the first drawer into a first cavity; and
evacuating the first cavity and first drawer.

22. The method of claim 21, further comprising opening the first drawer.

23. The method of claim 22, further comprising using the food.

24. The method of claim 21, further comprising:
filling a second drawer;
inserting the second drawer into a second cavity; and
evacuating the first cavity, second cavity, first drawer and second drawer.

25. The method of claim 24, further comprising opening the first drawer without unsealing the second drawer.

26. The method of claim 25, further comprising connecting a set of modules, modules of the set of modules including the first drawer, second drawer, first cavity and second cavity.

27. The method of claim 25, further comprising disconnecting modules of the set of modules.

28. The method of claim 26, wherein:
inserting the first drawer into the first cavity includes:
mating a valve of the first drawer with a valve of the cavity; and
sealing the cavity.

29. The method of claim 26, wherein connecting the modules of the set of modules includes mating a valve of a first module of the set of modules with a valve of a second module of the set of modules.

30. The method of claim 21, wherein:
inserting the first drawer into the first cavity includes:
mating a valve of the first drawer with a valve of the cavity; and
sealing the cavity.

31. A method for storing product, the method comprising:
providing an apparatus including a plurality of removable modules for storing said product, said modules arranged such that a single evacuation process can be used to evacuate said modules;
evacuating said modules to a first vacuum level;
monitoring a second vacuum level of said apparatus, wherein said second vacuum level is a vacuum level that is existing in said apparatus at any given point in time;
determining whether said second vacuum level of said apparatus has degraded; and
further evacuating said modules when said second vacuum level has degraded to a predefined vacuum level.
